(19) United States
(12) Patent Application Publication
(10) Pub. No.: US 2026/0313285 A1
(43) Pub. Date: Oct. 8, 2026

(54) HEADPHONE

(71) Applicant: Shenzhen Dancing Future Technology Ltd., Shenzhen (CN)

(72) Inventors: Ju YANG, Shenzhen (CN); Lijin LIAO, Shenzhen (CN); Haoqian LI, Shenzhen (CN)

(21) Appl. No.: 19/482,216

(22) PCT Filed: Jun. 28, 2024
(86) PCT No.: PCT/CN2024/102689

§ 371 Date: Nov. 6, 2025

(30) Foreign Application Priority Data
Jun. 30, 2023 (CN) 202310794694.X

(51) Int. Cl. H04R 1/10

(52) U.S. Cl. CPC H04R 1/105; H04R 1/1016; H04R 1/1066

(57) ABSTRACT

A headphone, including: a main body portion including a sound emitting section and an extension section, and in a wearing state, the extension section forms a first contact position with an upper edge of an ear; a connection portion located between a rear side of the ear and a head in the wearing state, and curved and extended from an upper side of the ear to a lower side of the ear; and a curved portion forming a second contact position with the rear side of the ear; and the first contact position and the second contact position are subjected to mechanical abstraction to obtain a first contact point and a second contact point, and a linear distance between projections of the first contact point and the second contact point on a first reference plane is kept unchanged in the wearing state relative to a natural state.

The present application claims priority to Chinese Patent Application No. 202310794694X, filed with the China National Intellectual Property Administration on Jun. 30, 2023 and entitled “HEADPHONE”, which is hereby incorporated by reference in its entirety.

### TECHNICAL FIELD

The present application relates to the technical field of consumer electronic products, and in particular, to a headphone.

### BACKGROUND

With the development of society, headphones are used in a wider and wider range of applications, and are widely used in office environments and when listening to music or entertainment anywhere.

At present, most open headphones are worn by using a clamping force generated by elastic deformation of the headphones, and this wearing manner will cause the ears to be deformed by pressure, so that pain is easily generated, and the comfort of this wearing manner is poor.

### SUMMARY

A main objective of the present application is to provide a headphone, which aims to improve wearing comfort of the headphone and improve user experience.

To achieve the above objective, the present application provides a headphone, including: a main body portion, a connection portion, and a curved portion;

the main body portion includes a sound emitting section and an extension section, one end of the extension section is connected to the sound emitting section, and the other end of the extension section is curved toward the curved portion and is in transitional connection with the curved portion; one end of the sound emitting section is connected to the extension section, and the other end of the sound emitting section is a second free end; in a wearing state, the extension section is curved and extended from a front side of an ear, over an upper edge of the ear, to a rear side of the ear, and forms a first contact position with the upper edge of the ear;

the connection portion is configured to connect the main body portion and the curved portion, and in the wearing state, the connection portion is located between the rear side of the ear and a head, and is curved and extended along the rear side of the ear from top to bottom;

one end of the curved portion is connected to the connection portion and the other end of the curved portion is a first free end, and in the wearing state, the curved portion is extended downward along a contour of the rear side of the ear, and forms at least one second contact position with the rear side of the ear or the head; and

the first contact position and the second contact position are respectively subjected to mechanical abstraction to obtain a first contact point and a second contact point, and the first contact point and the second contact point are respectively used as mechanical action points of the ear on the first contact position and the second contact position; and

a linear distance between projections of the first contact point and the second contact point on a first reference plane parallel to a sagittal plane of a human body is kept unchanged in the wearing state relative to a natural state.

A further technical solution of the present application is that a linear distance between projections of the first contact point and the second contact point on a second reference plane parallel to a horizontal plane of the human body is kept unchanged in the wearing state relative to the natural state.

A further technical solution of the present application is that a linear distance between projections of the first contact point and the second contact point on a third reference plane parallel to a coronal plane of the human body is kept unchanged in the wearing state relative to the natural state.

A further technical solution of the present application is that, in the wearing state relative to the natural state, a minimum distance from the first free end to a first side surface of the connection portion close to the ear is unchanged, a minimum distance from the first free end to a second side surface of the extension section close to the ear is unchanged, and a minimum distance from a first end of the first side surface connected to the curved portion to a second end of the second side surface connected to the connection portion is unchanged.

A further technical solution of the present application is that the sound emitting section forms a third contact position with the front side of the ear, the third contact position is subjected to mechanical abstraction to obtain a third contact point, and the third contact point is used as a mechanical action point of the ear on the third contact position.

A further technical solution of the present application is that, in the wearing state relative to the natural state, a linear distance between projections of any two of the first contact point, the second contact point, and the third contact point on the first reference plane is kept unchanged.

A further technical solution of the present application is that, in the wearing state relative to the natural state, a linear distance between projections of any two of the first contact point, the second contact point, and the third contact point on a second reference plane parallel to a horizontal plane of the human body is kept unchanged.

A further technical solution of the present application is that, in the wearing state relative to the natural state, a linear distance between projections of any two of the first contact point, the second contact point, and the third contact point on a third reference plane parallel to a coronal plane of the human body is kept unchanged.

A further technical solution of the present application is that, in the wearing state relative to the natural state, a minimum distance from the second free end to a first side surface of the connection portion close to the ear is unchanged, a minimum distance from the second free end to a second side surface of the extension section close to the ear is unchanged, and a minimum distance from the second free end to the first free end is unchanged;

a minimum distance from the first free end to the first side surface of the connection portion close to the ear is unchanged; and a minimum distance from the first free end to the second side surface of the extension section close to the ear is unchanged.

A further technical solution of the present application is that the connection portion has elasticity, and the main body portion and the curved portion are both formed by hard materials.

A further technical solution of the present application is that an elastic metal strip connecting the extension section and the curved portion is disposed inside the connection portion, and the elastic metal strip has a diameter greater than or equal to 0.8 mm.

A further technical solution of the present application is that the connection portion has elasticity, and in the wearing state relative to the natural state, a shape, an overlapping proportion, and a position of an overlapping portion of an orthographic projection of the curved portion on a second reference plane parallel to a horizontal plane and an orthographic projection of the sound emitting section on the second reference plane are unchanged.

A further technical solution of the present application is that the ear forms a first supporting force F1 for the headphone at a position corresponding to the first contact point, and the first supporting force F1 is directed outward and upward, and an included angle between the first supporting force F1 and an X direction is greater than 60° and less than 150°.

A further technical solution of the present application is that a contact position of the ear corresponding to the first contact position is located between an upper root of the ear and an upper vertex of a helix tubercle.

A further technical solution of the present application is that a length L direction of the sound emitting section is extended from a crus of helix of the ear to an anti-helix direction.

A further technical solution of the present application is that the sound emitting section forms the third contact position with an inner wall of a concha of the ear.

A further technical solution of the present application is that the sound emitting section includes, in a thickness direction, a fitting portion for fitting with the concha and a shell portion located outside the concha, the third contact position is located on the fitting portion, and the fitting portion has a thickness h3 of 2-10 mm.

A further technical solution of the present application is that the sound emitting section is inclined from an end connected to the extension section to the second free end in a direction away from a tragus of the ear, so that there is a gap d between a bottom surface of the sound emitting section close to the tragus and the tragus, and the gap d is greater than or equal to 0.

A further technical solution of the present application is that the first contact point, the second contact point, and the third contact point form a triangle in space.

A further technical solution of the present application is that the sound emitting section has a boss protruding toward an ear hole of the ear, and the sound outlet hole is disposed in the boss.

A further technical solution of the present application is that a distance between the first contact point and the third contact point in a coronal axis direction is 3.5 -13.5 mm.

A further technical solution of the present application is that the extension section has a transition curve on a side facing the ear at a bending transition position with the sound emitting section, and a range of a radius of curvature corresponding to a projection curve of the transition curve on the first reference plane is 1-10 mm.

A further technical solution of the present application is that the extension section has a cross-sectional area that tapers from an end close to the sound emitting section to the other end.

A further technical solution of the present application is that the sound emitting section has a thickness h1 of 8-20 mm.

A further technical solution of the present application is that a length ratio of the extension section to the sound emitting section in a sagittal axis direction is 0.2-1.

A further technical solution of the present application is that a length of the sound emitting section in the sagittal axis direction ranges from 15 to 25 mm.

A further technical solution of the present application is that a length ratio of the connection portion to the curved portion in the sagittal axis direction is less than 1.

A further technical solution of the present application is that a length of the curved portion in the sagittal axis direction ranges from 30 to 45 mm.

A further technical solution of the present application is that a projection of a first side surface of the connection portion close to the ear on the first reference plane forms a first curve, a projection of the sound emitting section on the first reference plane forms a second curve, the first curve and the second curve have a spacing in a vertical axis direction, and the spacing is gradually narrowed from a side close to the curved portion to a side close to the extension section.

A further technical solution of the present application is that the connection portion has a cross-sectional area that first gradually decreases and then gradually increases from an end close to the extension section to an end close to the curved portion.

A further technical solution of the present application is that the connection portion has a maximum outer diameter less than or equal to 15 mm.

A further technical solution of the present application is that the curved portion includes a transition section with a cross section that tapers in a direction toward the connection portion and a columnar contact section, and the second contact position is located on the contact section.

A further technical solution of the present application is that a ratio of a thickness h2 to a width w2 of the contact section is less than 1.

A further technical solution of the present application is that the contact section has a thickness h2 of 5 -15 mm.

A further technical solution of the present application is that a side surface of the curved portion is formed by smooth transition connection of a plurality of planes/curved surfaces, so that the second contact position is a plane whose inclination angle matches with a contour of the ear or a curved surface whose curvature matches with the contour of the ear.

A further technical solution of the present application is that a total mass M of the curved portion and the connection portion and a total mass m of the main body portion satisfy a difference of |M-m| less than 5 g.

According to the above technical solutions of the present application, the linear distance between the projections of the first contact point and the second contact point on the first reference plane parallel to the sagittal plane of the human body is kept unchanged in the wearing state relative to the natural state, that is, no elastic deformation occurs between the first contact point and the second contact point in the first reference plane, and no clamping force generated by the elastic deformation is applied to the ear in the first reference plane. Thus, when the headphone is worn, no clamping force is applied to the ear, and the wearing comfort of the user is improved.

### BRIEF DESCRIPTION OF DRAWINGS

In order to more clearly illustrate the technical solutions in the embodiments of the present application or in the prior art, the following briefly introduces the drawings required for describing the embodiments or the prior art. Obviously, the drawings in the following description show merely some embodiments of the present application, and a person of ordinary skill in the art may still derive other drawings from these drawings without creative efforts.

FIG. 1 is a schematic diagram illustrating the structure of an ear;

FIG. 2 is a schematic front view of a wearing state of a headphone according to any embodiment of the present application;

FIG. 3 is a schematic top view of FIG. 2;

FIG. 4 is a schematic left view of FIG. 2;

FIG. 5 is a schematic right view of FIG. 2;

FIG. 6 is a schematic front view of a natural state of a headphone according to any embodiment of the present application;

FIG. 7 is another schematic front view of the natural state of the headphone according to any embodiment of the present application;

FIG. 8 is a schematic rear view of FIG. 6;

FIG. 9 is a schematic left view of FIG. 6;

FIG. 10 is a schematic right view of FIG. 6;

FIG. 11 is a schematic top view of FIG. 6;

FIG. 12 is a schematic bottom view of FIG. 6;

FIG. 13 is a schematic diagram illustrating another angle of the natural state of the headphone according to any embodiment of the present application; and

FIG. 14 is a schematic diagram illustrating the internal structure of the natural state of the headphone according to any embodiment of the present application.

### DESCRIPTION OF REFERENCE NUMERALS IN THE DRAWINGS

main body portion 10; connection portion 20; curved portion 30; sound emitting section 40; extension section 50; first contact position 60; third contact position 70; second contact position 80; second free end 90; first contact point A; second contact point B; third contact point C; first free end 100; first side surface 110; second side surface 120; first end 130; second end 140; elastic metal strip 150; boss 160; sound outlet hole 170; transition curve 180; first curve 190; second curve 200; transition section 210; contact section 220; inclined surface 230; fitting portion 240; and shell portion 250.

The objective, functional features, and advantages of the present application are further described below with reference to the drawings and in conjunction with the embodiments.

### DETAILED DESCRIPTION

In order to make the objective, technical solutions, and advantages of the present application clearer, the technical solutions in the embodiments of the present application are clearly and completely described below with reference to the embodiments of the present application. Apparently, the described embodiments are some but not all of the embodiments of the present application. All other embodiments obtained by a person of ordinary skill in the art based on the embodiments of the present application without creative efforts shall fall within the protection scope of the present application. The embodiments described below and the features of the embodiments may be combined with each other without conflict.

The following first describes the definitions of the wearing state, the front side, the rear side, the upper side, and the lower side of the ear, the sagittal plane, the coronal plane, the horizontal plane of the human body, the sagittal axis, the coronal axis, the horizontal axis, and the X, Y, and Z directions involved in the text.

The front side and the rear side of the ear are defined as follows: the “front side of the ear” described in the present application is a concept relative to the “rear side of the ear”, the former refers to a side of the ear away from the head, and the latter refers to a side of the ear close to the head; an “upper edge of the ear” refers to an outer edge of an upward side of the helix of the ear, and a “lower edge of the ear” refers to an outer edge of a downward side of the helix of the ear, which are all for the ear of the user.

The sagittal plane, the coronal plane, the horizontal plane, the sagittal axis, the coronal axis, and the horizontal axis of the human body are defined as follows: as is well known, in the fields of medicine, anatomy, and the like, three basic sections of the human body, namely, the sagittal plane (Sagittal Plane), the coronal plane (Coronal Plane), and the horizontal plane (Horizontal Plane), and three basic axes, namely, the sagittal axis (Sagittal Axis), the coronal axis (Coronal Axis), and the vertical axis (Vertical Axis) may be defined. The sagittal plane refers to a section perpendicular to the ground and made along the front-back direction of the body, which divides the human body into left and right parts; the coronal plane refers to a section perpendicular to the ground and made along the left-right direction of the body, which divides the human body into front and rear parts; and the horizontal plane refers to a section parallel to the ground and made along the up-down direction of the body, which divides the human body into upper and lower parts. Correspondingly, the sagittal axis refers to an axis that is along the front-back direction of the body and passes through the coronal plane vertically, the coronal axis refers to an axis that is along the left-right direction of the body and passes through the sagittal plane vertically, and the vertical axis refers to an axis that is along the up-down direction of the body and passes through the horizontal plane vertically.

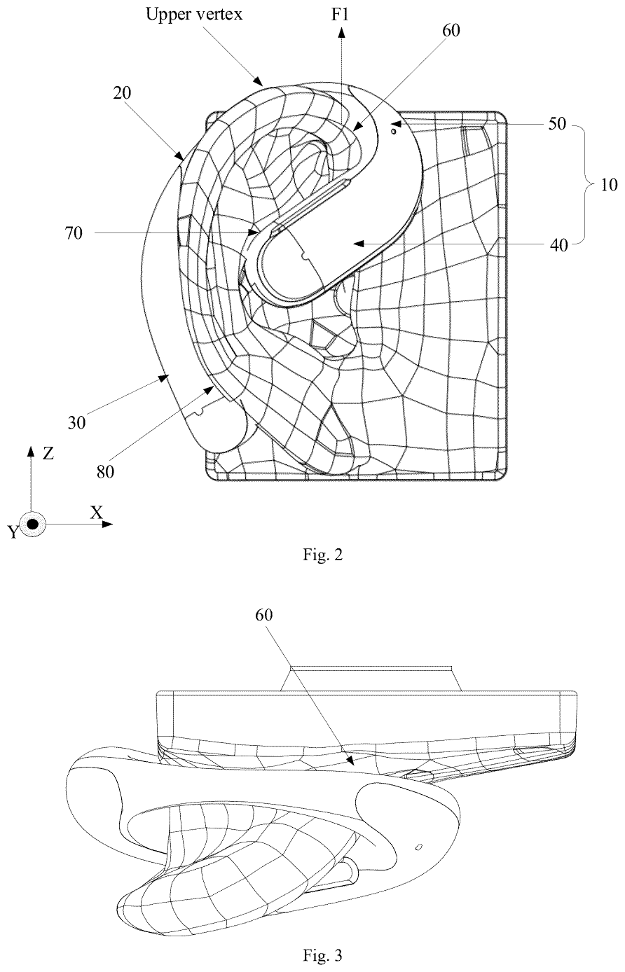

The X, Y, and Z directions are defined as follows: as shown in FIG. 2, for ease of description, the X, Y, and Z directions are defined, the X direction is defined as being parallel to the sagittal axis and pointing to the front of the human body, the Y direction is defined as being parallel to the coronal axis and pointing to the right side of the human body (out of the paper surface of FIG. 2), and the Z direction is defined as being parallel to the vertical axis and pointing to the upper side of the human body.

The above definitions of directions are only for ease of description, and the X, Y, and Z directions may be defined arbitrarily in accordance with the principles of the technical solutions, including but not limited to the definition methods such as axial symmetry and angular symmetry of the above orientations.

The wearing state and the natural state are defined as follows: a simulator including a head and the (left and right) ears thereof may be made based on the standards ANSI: S3.36, S3.25 and IEC: 60318-7, for example, GRAS KB0065. Based on this, the “wearing state” described in the present application is a stable wearing state after the headphone is stably worn on the ear of the simulator (as shown in FIG. 2), and the “natural state” is a state in which the headphone is not subjected to any external force after being removed from the ear. Certainly, due to individual differences among users, the actual wearing state of the headphone may be somewhat different from the wearing state described above.

The following comparison between the wearing state and the natural state is made in the following manner: in the wearing state, the headphone forms a corresponding first contact point A, a corresponding second contact point B, and a corresponding third contact point C with the ear, which are marked, and then compared with the first contact point A, the second contact point B, and the third contact point C in the natural state after the headphone is removed. For ease of description, the circles corresponding to all the first contact points A, the second contact points B, and the third contact points C in the drawings of the present application are only schematic illustrations of approximate positions, and are not displays of actual positions.

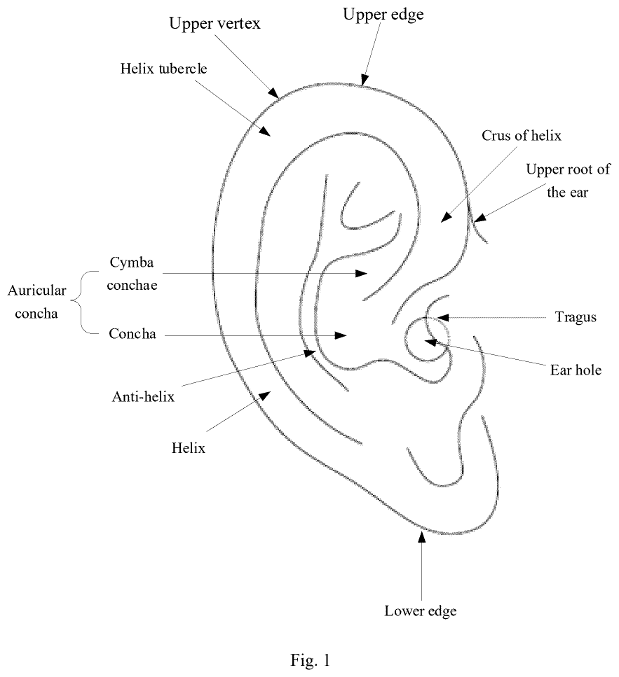

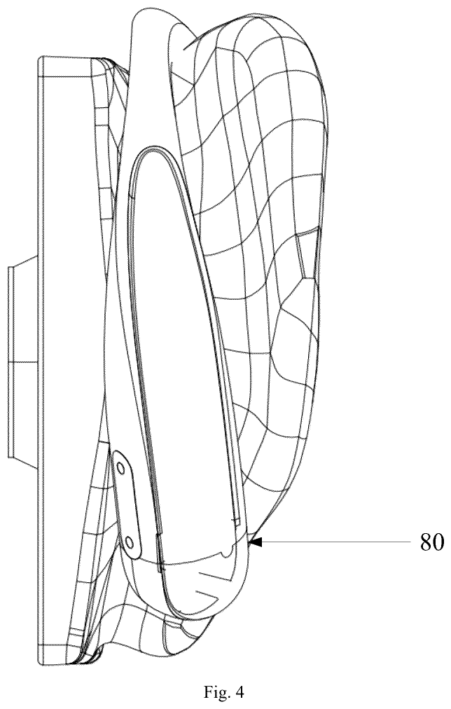

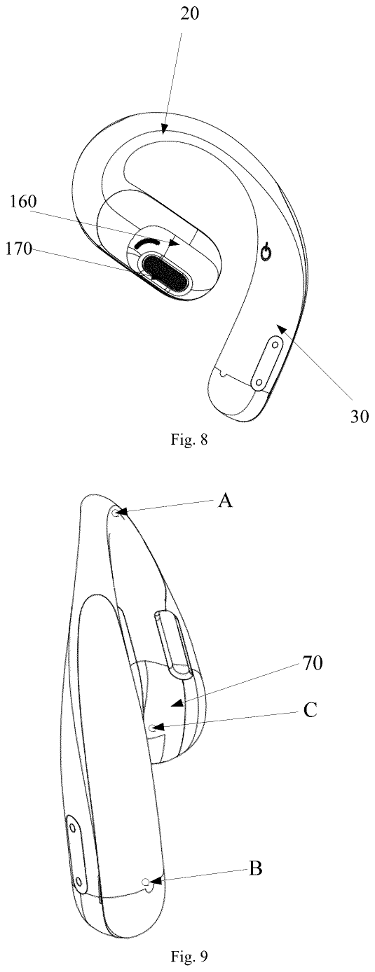

The present application provides a headphone. Referring to FIG. 1 to FIG. 14, the present application provides an embodiment, and the embodiment includes a main body portion 10, a connection portion 20, and a curved portion 30. The main body portion 10 includes a sound emitting section 40 and an extension section 50, one end of the extension section 50 is connected to the sound emitting section 40, and the other end of the extension section 50 is curved toward the curved portion 30 and is in transitional connection with the curved portion 30; one end of the sound emitting section 40 is connected to the extension section 50, and the other end of the sound emitting section 40 is a second free end 90; and in a wearing state, the extension section 50 is curved and extended from a front side of an ear, over an upper edge of the ear, to a rear side of the ear, and forms a first contact position 60 with the upper edge of the ear.

The connection portion 20 is configured to connect the main body portion 10 and the curved portion 30, and in the wearing state, the connection portion 20 is located between the rear side of the ear and a head, and is curved and extended along the rear side of the ear from top to bottom. The curved portion 30 has one end connected to the connection portion 20 and the other end being a first free end 100, and in the wearing state, the curved portion 30 is extended downward along a contour of the rear side of the ear, and forms at least one second contact position 80 with the rear side of the ear or the head.

The first contact position 60 and the second contact position 80 are respectively subjected to mechanical abstraction to obtain a first contact point A and a second contact point B, and the first contact point A and the second contact point B are respectively used as mechanical action points of the ear on the first contact position 60 and the second contact position 80. A linear distance between projections of the first contact point A and the second contact point B on a first reference plane (ZX plane) parallel to a sagittal plane of a human body is kept unchanged in the wearing state relative to a natural state.

It should be pointed out that in the present embodiment, the linear distance between the first contact point A and the second contact point B in the first reference plane is kept unchanged in the wearing state relative to the natural state, that is, no elastic deformation occurs between the first contact point A and the second contact point B in the first reference plane, and no clamping force generated by the elastic deformation is applied to the ear in the first reference plane, thereby improving wearing comfort.

In addition, in this state, the headphone does not require the clamping force generated by the elastic deformation, and the wearing stability may be maintained only by a supporting force and a corresponding frictional force of the first contact position 60 and the second contact position 80.

Further, a linear distance between projections of the first contact point A and the second contact point B on a second reference plane (YX plane) parallel to a horizontal plane of the human body is kept unchanged in the wearing state relative to the natural state. The linear distance between the projections of the first contact point A and the second contact point B on the second reference plane is kept unchanged in the wearing state relative to the natural state, that is, no elastic deformation occurs in the second reference plane, and thus no clamping force generated by the elastic deformation is applied to the ear in the second reference plane, thereby improving wearing comfort.

Further, a linear distance between projections of the first contact point A and the second contact point B on a third reference plane (ZY plane) parallel to a coronal plane of the human body is kept unchanged in the wearing state relative to the natural state. The linear distance between the projections of the first contact point A and the second contact point B on the third reference plane is kept unchanged in the wearing state relative to the natural state, that is, no elastic deformation occurs in the third reference plane, and thus no clamping force generated by the elastic deformation is applied to the ear in the third reference plane, thereby improving wearing comfort.

Exemplarily, in the wearing state relative to the natural state, a minimum distance from the first free end 100 to a first side surface 110 of the connection portion 20 close to the ear is unchanged, a minimum distance from the first free end 100 to a second side surface 120 of the extension section 50 close to the ear is unchanged, and a minimum distance from a first end 130 of the first side surface 110 connected to the curved portion 30 to a second end 140 of the second side surface 120 connected to the connection portion 20 is unchanged. With this configuration, in the wearing state relative to the natural state, no elastic deformation occurs among the bending section, the connection portion 20, and the extension section 50, that is, an absolute position of the first contact point A relative to the second contact point B in space is unchanged, and no clamping force generated by the elastic deformation is applied to the ear, thereby improving wearing comfort.

Continuing to refer to FIG. 2 to FIG. 14, another embodiment is provided in the present application. The difference between this embodiment and the above embodiment lies in that the sound emitting section 40 forms a third contact position 70 with the front side of the ear, the third contact position 70 is subjected to mechanical abstraction to obtain a third contact point C, and the third contact point C is used as a mechanical action point of the ear on the third contact position 70. In the present embodiment, by adding the third contact point C between the sound emitting section 40 and the front side of the ear, the wearing stability of the headphone may be further improved.

Further, in the wearing state relative to the natural state, a linear distance between projections of any two of the first contact point A, the second contact point B, and the third contact point C on the first reference plane is kept unchanged. With this configuration, the linear distance between any two points on the first reference plane is kept unchanged, that is, no elastic deformation occurs on the first reference plane, and no clamping force generated by the elastic deformation is applied to the ear, thereby improving wearing comfort.

Further, in the wearing state relative to the natural state, a linear distance between projections of any two of the first contact point A, the second contact point B, and the third contact point C on a second reference plane parallel to a horizontal plane of the human body is kept unchanged. With this configuration, the linear distance between any two points on the second reference plane is kept unchanged, that is, no elastic deformation occurs on the second reference plane, and no clamping force generated by the elastic deformation is applied to the ear, thereby improving wearing comfort.

Further, in the wearing state relative to the natural state, a linear distance between projections of any two of the first contact point A, the second contact point B, and the third contact point C on a third reference plane parallel to a coronal plane of the human body is kept unchanged. With this configuration, the linear distance between any two points on the third reference plane is kept unchanged, that is, no elastic deformation occurs on the third reference plane, and no clamping force generated by the elastic deformation is applied to the ear, thereby improving wearing comfort.

Exemplarily, in the wearing state relative to the natural state, a minimum distance from the second free end 90 to the first side surface 110 of the connection portion 20 close to the ear is unchanged, a minimum distance from the second free end 90 to the second side surface 120 of the extension section 50 close to the ear is unchanged, and a minimum distance from the second free end 90 to the first free end 100 is unchanged; and a minimum distance from the first free end 100 to the first side surface 110 of the connection portion 20 close to the ear is unchanged; and a minimum distance from the first free end 100 to the second side surface 120 of the extension section 50 close to the ear is unchanged. With this configuration, a spatial position of the first free end 100 relative to the second free end 90 is unchanged, so that no elastic deformation occurs among various parts of the headphone, such as the sound emitting section 40, the connection portion 20, the curved portion 30, and the extension section 50, and the headphone has no elastic deformation, that is, an absolute position between any two of the first, second, and third contact points C is unchanged, and no clamping force generated by the elastic deformation is applied to the ear, thereby improving wearing comfort.

Further, the first contact point A, the second contact point B, and the third contact point C form a triangle in space. This configuration makes the headphone worn more stably and reliably.

Further, a distance between the first contact point A and the third contact point C in a coronal axis direction is 3.5 -13.5 mm. Within this distance range, the thickness of the ear of most users may be matched, and the ear is prevented from being squeezed in the thickness direction of the ear, while a stable support may be provided. As a preferred implementation, the distance may be set to 5.5 to 11.5 mm, further preferably 6.5 to 10.5 mm, and still further preferably 8.5 mm.

For any of the above embodiments, further, the connection portion 20 has elasticity, and the main body portion 10 and the curved portion 30 are both formed by hard materials. In order to expand a spacing between the main body portion 10 and the curved portion 30 during the wearing process to facilitate the wearing process for the user, the connection portion 20 is configured to be elastic, but after the wearing is completed, the main body portion 10 and the curved portion 30 are restored to the natural state, and no clamping force generated by the elastic deformation is applied to the ear, thereby maintaining wearing comfort.

The main body portion 10 and the curved portion 30 being formed by hard materials means that main skeletons of the main body portion 10 and the curved portion 30 are made of materials with great rigidity, so that the overall structure is not easily deformed. The exterior of the connection portion 20, the main body portion 10, and the curved portion 30 may be covered or not covered with a flexible material (such as polycarbonate, polyamide, acrylonitrile-butadiene-styrene copolymer, and silica gel) as needed, or may be partially or completely covered with the flexible material as needed, so as to improve wearing comfort as needed.

The above hard materials refer to materials with great rigidity that are not easily deformed under normal circumstances, and materials with an elastic modulus greater than 2.0 GPa may be preferably selected, including but not limited to polycarbonate (PC), polyamides (PA), acrylonitrile butadiene styrene (ABS), polystyrene (PS), high impact polystyrene (HIPS), polypropylene (PP), polyethylene terephthalate (PET), polyvinyl chloride (PVC), polyurethanes (PU), polyethylene (PE), phenol formaldehyde (PF), poly(ester sulfones) (PES), polyvinylidene chloride (PVDC), polymethyl methacrylate (PMMA), poly-ether-ether-ketone (PEEK), etc., or mixtures formed by at least two of them, or mixtures formed by them and reinforcing agents such as glass fiber and carbon fiber.

As a preferred implementation, the selected hard material has an elastic modulus greater than 2.32 GPa and a Poisson's ratio of about 0.390212, such as a PC material.

For any of the above embodiments, exemplarily, an elastic metal strip 150 connecting the extension section 50 and the curved portion 30 is disposed inside the connection portion 20, and the elastic metal strip 150 has a diameter greater than or equal to 0.8 mm. The elastic metal strip 150 with the diameter within this range is selected, so that certain elasticity may be maintained, and at the same time, certain rigidity is maintained, so that the elastic metal strip is not easily broken or curved, the shape of the headphone may be maintained when the headphone is worn, the pressure on the ear is reduced, and at the same time, the number of bending times is reduced, and the internal flexible circuit board is protected. As a preferred implementation, the diameter is greater than or equal to 1 mm. In order to prevent the elastic metal strip 150 from being too thick and difficult to bend, the diameter in the present embodiment may be further preferably less than 2 mm.

In order to better protect the circuit board and prevent the circuit board from being damaged when the connection portion 20 is curved, the elastic metal strip 150 and the flexible circuit board in the connection portion 20 are arranged side by side and extend in the same direction.

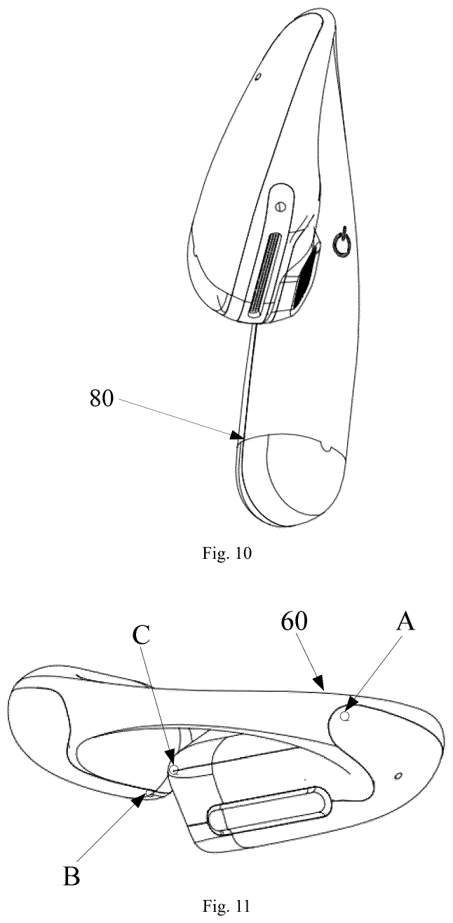

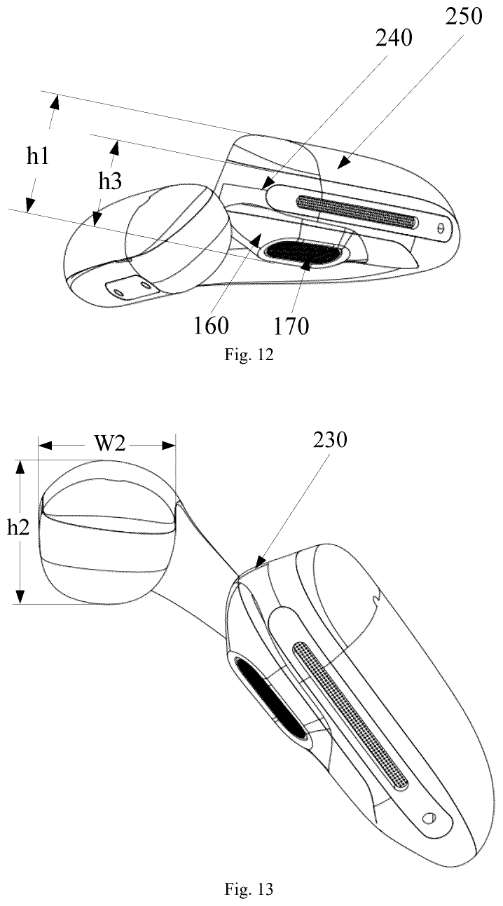

For any of the above embodiments, further, as shown in FIG. 11 and FIG. 12, the connection portion 20 has elasticity, and in the wearing state relative to the natural state, a shape, an overlapping proportion, and a position of an overlapping portion of an orthographic projection of the curved portion 30 on the second reference plane parallel to the horizontal plane and an orthographic projection of the sound emitting section on the second reference plane are unchanged. That is, for the present application, the overlapping portion is to make the shape of the headphone match with the ear shape better to increase the wearing stability, rather than to generate an elastic clamping force. The connection portion 20 has elasticity so that the spacing between the main body portion 10 and the curved portion 30 may be expanded during the wearing process to facilitate the wearing process for the user, but after the wearing is completed, the main body portion 10 and the curved portion 30 are restored to the natural state, and no clamping force generated by the elastic deformation is applied to the ear, thereby improving wearing comfort.

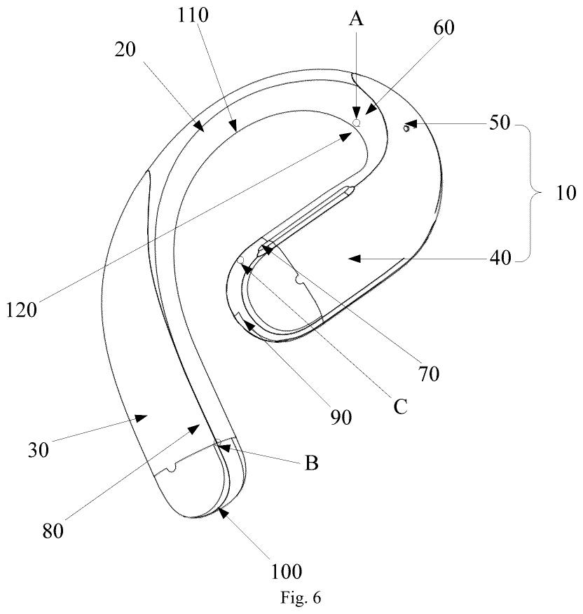

For any of the above embodiments, exemplarily, as shown in FIG. 6 to FIG. 8, in the wearing state and the natural state, orthographic projections of the main body portion 10 and the connection portion 20 on the first reference plane do not overlap, and a position and a shape of the orthographic projection of the main body portion 10 corresponding to the orthographic projection of the connection portion 20 on the first reference plane are unchanged. With this configuration, no elastic deformation occurs between the main body portion 10 and the connection portion 20 in the first reference plane, and no clamping force generated by the elastic deformation is applied to the ear, thereby improving wearing comfort.

For any of the above embodiments, exemplarily, as shown in FIG. 6 to FIG. 8, in the wearing state and the natural state, orthographic projections of the main body portion 10 and the curved portion 30 on the first reference plane do not overlap, and a position and a shape of the orthographic projection of the main body portion 10 corresponding to the orthographic projection of the curved portion 30 on the first reference plane are unchanged. With this configuration, no elastic deformation occurs between the main body portion 10 and the curved portion 30 in the first reference plane, and no clamping force generated by the elastic deformation is applied to the ear, thereby improving wearing comfort.

For any of the above embodiments, further, the ear forms a first supporting force F1 for the headphone at a position corresponding to the first contact point A, and the first supporting force F1 is directed outward and upward, and an included angle between the first supporting force F1 and an X direction is greater than 60° and less than 150°. For any of the above embodiments, the gravity is mainly overcome by the first supporting force F1, and the first supporting force F1 is in this direction to reduce the pressure on the ear as much as possible, thereby improving wearing comfort. More preferably, as shown in FIG. 2, the included angle between the first supporting force F1 and the X direction is 90°.

For any of the above embodiments, further, as shown in FIG. 2, a contact position of the ear corresponding to the first contact position 60 is located between an upper root of the ear and an upper vertex of a helix tubercle. Since the position of the upper root of the ear is more sensitive and prone to discomfort, the first contact position 60 is not in direct contact with the upper root of the ear; and when the contact position of the first contact position 60 with the ear exceeds the upper vertex of the helix tubercle, the headphone is not stably worn and is prone to slipping; therefore, wearing comfort and stability may be both taken into consideration when the contact position is within this range.

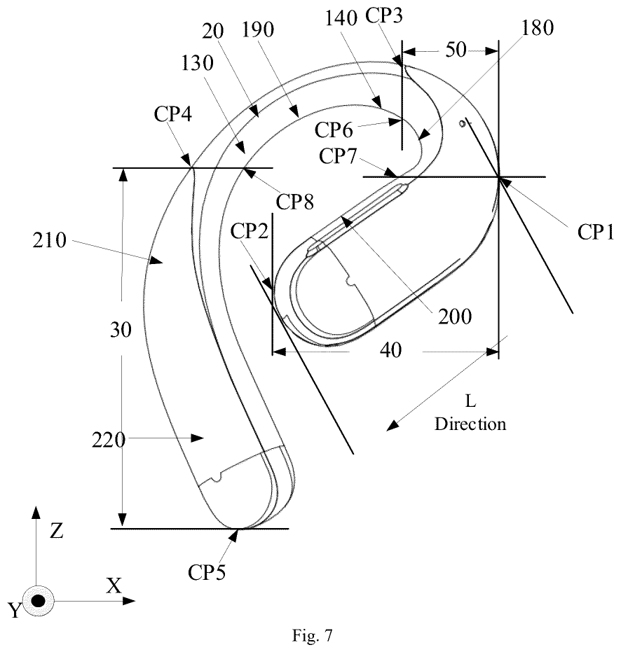

For any of the above embodiments, further, as shown in FIG. 7, a length L direction of the sound emitting section 40 is extended from a crus of helix of the ear to an anti-helix direction. The length L direction of the sound emitting section 40 is extended in this direction, so that the sound emitting section is less prone to squeezing and collision with the structure of the ear during the use, thereby improving wearing comfort.

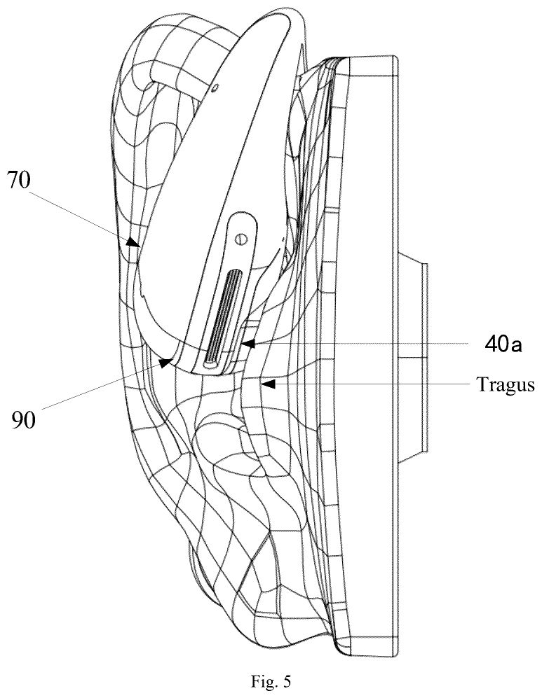

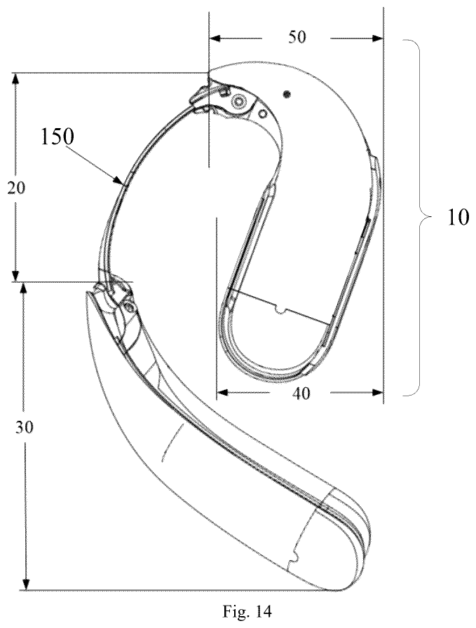

For some embodiments, further, as shown in FIG. 5, FIG. 12, and FIG. 13, the sound emitting section 40 forms the third contact position 70 with an inner wall of a concha of the ear, and the third contact position 70 is located in the concha, so that the wearing is more stable. Further, the sound emitting section 40 includes, in a thickness direction, a fitting portion 240 for fitting with the concha and a shell portion 250 located outside the concha, the third contact position 70 is located on the fitting portion 240, and the fitting portion 240 has a thickness h3 of 2-10 mm. The sound emitting section 40 is divided into the fitting portion 240 and the shell portion 250, so that the fitting portion 240 may be better improved as needed without affecting the arrangement of internal components of the sound emitting section 40, and the thickness h3 of the fitting portion 240 may be better matched with the depth of the concha. Preferably, the fitting portion 240 has a thickness h3 of 3-9 mm, and more preferably 4-8 mm. In order to further improve the wearing stability, the fitting portion 240 is provided with an inclined surface 230 matching with the shape of the concha.

For any of the above embodiments, further, as shown in FIG. 5, the sound emitting section 40 is inclined from an end connected to the extension section 50 to the second free end 90 in a direction away from a tragus of the ear, so that there is a gap d between a bottom surface 40a of the sound emitting section 40 close to the tragus and the tragus, and the gap d is greater than or equal to 0. With this configuration, the sound emitting section 40 is prevented from squeezing the tragus in the wearing state, thereby improving wearing comfort.

For any of the above embodiments, further, as shown in FIG. 12, the sound emitting section 40 has a boss 160 protruding toward an ear hole of the ear, and a sound outlet hole 170 is formed in the boss 160. The boss 160 may form contact with the ear during the movement while improving the sound quality, thereby further improving the wearing stability.

For any of the above embodiments, exemplarily, referring to FIG. 7 and FIG. 14, specific ranges of the sound emitting section 40, the extension section 50, the connection portion 20, and the curved portion 30 are as follows: a start point of the sound emitting section 40 is a rightmost first endpoint CP1 of the main body portion 10, and an end point of the sound emitting section 40 is a leftmost second endpoint CP2 of the sound emitting section 40; a start point of the extension section 50 is the rightmost first endpoint CP1 of the main body portion 10, and an end point of the extension section 50 is a leftmost third endpoint CP3 of an end of the main body portion 10 connected to the elastic metal strip 150; a start point of the connection portion 20 is the leftmost third endpoint CP3 of the end of the main body portion 10 connected to the elastic metal strip 150, and an end point of the connection portion 20 is an uppermost fourth endpoint CP4 of an end of the curved portion 30 connected to the elastic metal strip 150; and a start point of the curved portion 30 is the uppermost fourth endpoint CP4 of the end of the curved portion 30 connected to the elastic metal strip 150, and an end point of the curved portion 30 is a lowermost fifth endpoint CP5 of the curved portion 30. The following numerical ranges of each part are based on the defined ranges.

Further, as shown in FIG. 7 and FIG. 14, the extension section 50 has a transition curve 180 on a side facing the ear at a bending transition position with the sound emitting section 40, and a range of a radius of curvature corresponding to a projection curve of the transition curve 180 on the first reference plane is 1-10 mm. Within this range of the radius of curvature, the ears of most users may be accommodated, and the ears are prevented from being squeezed, while good wearing stability is maintained. Exemplarily, a start point of the transition curve 180 is a first intersection point CP6 of a reverse extension line of the third endpoint CP3 in a Z direction and a side surface of the extension section 50 close to the ear, and an end point of the transition curve 180 is a second intersection point CP7 of a reverse extension line of the first endpoint CP1 in an X direction and the side surface of the extension section 50 close to the ear. Preferably, the range of the radius of curvature is 2-8 mm, and more preferably, the range of the radius of curvature is 3-7 mm.

Exemplarily, as shown in FIG. 7 and FIG. 14, the extension section 50 has a cross-sectional area that tapers from an end close to the sound emitting section 40 to the other end. This shape of the extension section 50 fits with the gap between the ear and the head, and prevents the ear from being squeezed during the wearing process. Further, the sound emitting section 40 has a thickness h1 of 8-20 mm, preferably 9-18 mm, and more preferably 10-16 mm.

Exemplarily, as shown in FIG. 7 and FIG. 14, a length ratio of the extension section 50 to the sound emitting section 40 in the sagittal axis direction is 0.2-1. A numerical value is controlled within this range to control a length of the extension section 50, so that a bending position between the sound emitting section 40 and the extension section 50 is prevented from being too far from the first contact position when the headphone is worn, which affects wearing stability. Preferably, the length ratio of the extension section 50 to the sound emitting section 40 in the sagittal axis direction is 0.3-0.9, and more preferably, the length ratio is 0.4-0.8. Further, a length of the sound emitting section 40 in the sagittal axis direction ranges from 15 to 25 mm, preferably from 17 to 23 mm, and more preferably from 18 to 22 mm.

Exemplarily, as shown in FIG. 7 and FIG. 14, a length ratio of the connection portion 20 to the curved portion 30 in the sagittal axis direction is less than 1. This length ratio range may increase the length of the curved portion 30, so that the curved portion 30 may be in contact with the ear of the user to a greater extent, thereby improving wearing stability. Preferably, the length ratio of the connection portion 20 to the curved portion 30 in the sagittal axis direction is less than 0.9, and more preferably less than 0.8. Further, a length of the curved portion 30 in the sagittal axis direction ranges from 30 to 45 mm, preferably from 32 to 43 mm, and more preferably from 33 to 40 mm.

Exemplarily, as shown in FIG. 7 and FIG. 14, the projection of the first side surface 110 of the connection portion 20 close to the ear on the first reference plane forms the first curve 190, the projection of the sound emitting section 40 on the first reference plane forms the second curve 200, the first curve 190 and the second curve 200 have a spacing in the vertical axis direction, and the spacing is gradually narrowed from a side close to the curved portion 30 to a side close to the extension section 50. This configuration is beneficial for keeping a distance between the connection portion 20 and the ear in the wearing state, so that the connection portion 20 is prevented from directly squeezing the ear to cause discomfort. Specifically, a start point of the first curve 190 is the first intersection point CP6, and an end point of the first curve is a third intersection point CP8 of an extension line of the fourth endpoint CP4 in the X direction and the side surface of the connection portion close to the ear; and a start point of the second curve 200 is the second intersection point CP7, and an end point of the second curve 200 is the second endpoint CP2.

Exemplarily, as shown in FIG. 7 and FIG. 14, the connection portion 20 has a cross-sectional area that first gradually decreases and then gradually increases from an end close to the extension section 50 to an end close to the curved portion 30. This shape of the connection portion 20 reduces its volume as much as possible, prevents the ear or the head from being squeezed, and improves wearing comfort. Further, the connection portion 20 has a maximum outer diameter less than or equal to 15 mm, preferably less than or equal to 12 mm, and more preferably less than or equal to 10 mm.

Exemplarily, as shown in FIG. 7 and FIG. 14, the curved portion 30 includes a transition section 210 with a cross section that tapers in a direction toward the connection portion 20 and a columnar contact section 220, and the second contact position 80 is located on the contact section 220. With this shape, the volume of the transition section 210 may be reduced as much as possible to prevent the clamping force generated by the elastic deformation on the ear, the volume of the contact section 220 is expanded, the area of the second contact position 80 is increased, and wearing comfort and stability are improved.

Further, as shown in FIG. 7, FIG. 13, and FIG. 14, a ratio of a thickness h2 to a width w2 of the contact section 220 is less than 1. When the ratio is within this range, the contact section 220 is in a flat column shape, so that the area of the second contact position 80 may be better expanded, and wearing comfort may be improved. Preferably, the ratio of the thickness h2 to the width w2 of the contact section 220 is less than 0.9, and more preferably less than 0.8. Still further, the contact section 220 has a thickness h2 of 5 -15 mm, preferably 6-14 mm, and more preferably 8-13 mm.

Exemplarily, as shown in FIG. 6, FIG. 7, FIG. 13, and FIG. 14, the side surface of the curved portion 30 is formed by smooth transition connection of a plurality of planes/curved surfaces, so that the second contact position 80 is a plane whose inclination angle matches with a contour of the ear or a curved surface whose curvature matches with the contour of the ear. Through the splicing of the plurality of planes/curved surfaces, the second contact position 80 for contacting with the ear is a plane whose inclination angle matches with the ear shape or a curved surface whose curvature matches with the ear shape, so that the contact between the contact section 220 and the ear of the user is changed from the traditional point contact or line contact to surface contact, thereby expanding the surface area in contact with the ear, reducing the pressure on the ear, and improving wearing comfort for the user.

Exemplarily, as shown in FIG. 7 and FIG. 14, a total mass M of the curved portion 30 and the connection portion 20 and a total mass m of the main body portion 10 satisfy a difference of |M-m| less than 5 g. With this weight configuration, the weights on two sides of the first contact point A are kept balanced as much as possible, and the headphone is prevented from deflecting in the wearing state. Preferably, the difference of |M-m| is less than 4 g, more preferably, the difference of |M-m| is less than 3 g, and more preferably, the difference of |M-m| is 0.

The above description is only preferred embodiments of the present application, and is not intended to limit the patent scope of the present application. Under the concept of the present application, equivalent structural transformations made using the content of the description and drawings of the present application, or direct/indirect applications in other related technical fields are included in the patent protection scope of the present application.

1. A headphone, comprising: a main body portion, a connection portion, and a curved portion;
the main body portion comprises a sound emitting section and an extension section, one end of the extension section is connected to the sound emitting section, and the other end of the extension section is curved toward the curved portion and is in transitional connection with the curved portion; one end of the sound emitting section is connected to the extension section, and the other end of the sound emitting section is a second free end; in a wearing state, the extension section is curved and extended from a front side of an ear, over an upper edge of the ear, to a rear side of the ear, and forms a first contact position with the upper edge of the ear;
the connection portion is configured to connect the main body portion and the curved portion, and in the wearing state, the connection portion is located between the rear side of the ear and a head, and is curved and extended along the rear side of the ear from top to bottom;
one end of the curved portion is connected to the connection portion and the other end of the curved portion is a first free end, and in the wearing state, the curved portion is extended downward along a contour of the rear side of the ear, and forms at least one second contact position with the rear side of the ear or the head; and
the first contact position and the second contact position are respectively subjected to mechanical abstraction to obtain a first contact point and a second contact point, and the first contact point and the second contact point are respectively used as mechanical action points of the ear on the first contact position and the second contact position; and
a linear distance between projections of the first contact point and the second contact point on a first reference plane parallel to a sagittal plane of a human body is kept unchanged in the wearing state relative to a natural state.

2. The headphone of claim 1, wherein a linear distance between projections of the first contact point and the second contact point on a second reference plane parallel to a horizontal plane of the human body is kept unchanged in the wearing state relative to the natural state.

3. The headphone of claim 1, wherein a linear distance between projections of the first contact point and the second contact point on a third reference plane parallel to a coronal plane of the human body is kept unchanged in the wearing state relative to the natural state.

4. The headphone of claim 1, wherein, in the wearing state relative to the natural state, a minimum distance from the first free end to a first side surface of the connection portion close to the ear is unchanged, a minimum distance from the first free end to a second side surface of the extension section close to the ear is unchanged, and a minimum distance from a first end of the first side surface connected to the curved portion to a second end of the second side surface connected to the connection portion is unchanged.

5. The headphone of claim 1, wherein the sound emitting section forms a third contact position with the front side of the ear, the third contact position is subjected to mechanical abstraction to obtain a third contact point, and the third contact point is used as a mechanical action point of the ear on the third contact position.

6. The headphone of claim 5, wherein a linear distance between projections of any two of the first contact point, the second contact point, and the third contact point on the first reference plane is kept unchanged in the wearing state relative to the natural state.

7. The headphone of claim 5, wherein a linear distance between projections of any two of the first contact point, the second contact point, and the third contact point on a second reference plane parallel to a horizontal plane of the human body is kept unchanged in the wearing state relative to the natural state.

8. The headphone of claim 5, wherein a linear distance between projections of any two of the first contact point, the second contact point, and the third contact point on a third reference plane parallel to a coronal plane of the human body is kept unchanged in the wearing state relative to the natural state.

9. The headphone of claim 6, wherein, in the wearing state relative to the natural state, a minimum distance from the second free end to a first side surface of the connection portion close to the ear is unchanged, a minimum distance from the second free end to a second side surface of the extension section close to the ear is unchanged, and a minimum distance from the second free end to the first free end is unchanged;
a minimum distance from the first free end to the first side surface of the connection portion close to the ear is unchanged; and a minimum distance from the first free end to the second side surface of the extension section close to the ear is unchanged.

10-11. (canceled)

12. The headphone of claim 1, wherein the connection portion has elasticity, and in the wearing state relative to the natural state, a shape, an overlapping proportion, and a position of an overlapping portion of an orthographic projection of the curved portion on a second reference plane parallel to a horizontal plane and an orthographic projection of the sound emitting section on the second reference plane are unchanged.

13. The headphone of claim 1, wherein the ear forms a first supporting force F1 for the headphone at a position corresponding to the first contact point, and the first supporting force F1 is directed outward and upward, and an included angle between the first supporting force F1 and an X direction is greater than 60° and less than 150°.

14-18. (canceled)

19. The headphone of claim 5, wherein the first contact point, the second contact point, and the third contact point form a triangle in space.

20. The headphone of claim 5, wherein the sound emitting section has a boss protruding toward an ear hole of the ear, and a sound outlet hole is disposed in the boss.

21-22. (canceled)

23. The headphone of claim 1, wherein the extension section has a cross-sectional area that tapers from an end close to the sound emitting section to the other end.

24. (canceled)

25. The headphone of claim 1, wherein a length ratio of the extension section to the sound emitting section in a sagittal axis direction is 0.2-1.

26. (canceled)

27. The headphone of claim 1, wherein a length ratio of the connection portion to the curved portion in the sagittal axis direction is less than 1.

28. (canceled)

29. The headphone of claim 1, wherein a projection of a first side surface of the connection portion close to the ear on the first reference plane forms a first curve, a projection of the sound emitting section on the first reference plane forms a second curve, the first curve and the second curve have a spacing in a vertical axis direction, and the spacing is gradually narrowed from a side close to the curved portion to a side close to the extension section.

30. The headphone of claim 1, wherein the connection portion has a cross-sectional area that first gradually decreases and then gradually increases from an end close to the extension section to an end close to the curved portion.

31. (canceled)

32. The headphone of claim 1, wherein the curved portion comprises a transition section with a cross section that tapers in a direction toward the connection portion and a columnar contact section, and the second contact position is located on the contact section.

33-35. (canceled)

36. The headphone of claim 1, wherein a total mass M of the curved portion and the connection portion and a total mass m of the main body portion satisfy a difference of |M-m| less than 5 g.
